(19) United States
(12) Patent Application Publication
(10) Pub. No.: US 2026/0091759 A1
(43) Pub. Date: Apr. 2, 2026

(54) VEHICLE CONTROL APPARATUS, VEHICLE CONTROL METHOD, AND STORAGE MEDIUM

(71) Applicant: HONDA MOTOR CO., LTD., Tokyo (JP)

(72) Inventors: Koji Nomura, Tokyo (JP); Ryo Morosawa, Tokyo (JP); Seonghun Lee, Tokyo (JP); Genki Inohana, Tokyo (JP)

(21) Appl. No.: 19/410,378

(22) Filed: Dec. 5, 2025

Related U.S. Application Data
(63) Continuation of application No. 18/581,805, filed on Feb. 20, 2024.

(30) Foreign Application Priority Data
Mar. 3, 2023 (JP) 2023-032489

(51) Int. Cl. B60R 25/25; B60R 25/01; B60R 25/30; B60R 25/31; G06V 20/56; G06V 40/16; G06V 40/20; G07C 9/00

(52) U.S. Cl. CPC B60R 25/25; B60R 25/01; B60R 25/305; B60R 25/31; G06V 20/56; G06V 40/172; G06V 40/20; G07C 9/00563

(57) ABSTRACT

A vehicle control apparatus includes: an approach detection section detects a person around a vehicle; a start control section starts an image capturing unit mounted on the vehicle when the approach detection section detects a person; an authentication section authenticates the person detected as a user of the vehicle by using an image captured and decide authentication completion under a condition that the authentication is established an authentication criterion number of times or more; and an openable and closeable object operation control section brings an openable and closeable object operation unit into operation when the authentication section decides authentication completion. The openable and closeable object operation unit performs at least one of releasing a lock of an openable and closeable object and executing an opening operation of opening the openable and closeable object included in the vehicle.

### INCORPORATION BY REFERENCE

The present application is a continuation application of and claims priority under 35 U.S.C. § 120 to U.S. application Ser. No. 18/581805 filed on Feb. 20, 2024, and claims priority under 35 U.S.C. § 119 to Japanese Patent Application No. 2023-032489 filed on Mar. 3, 2023. The content of the priority applications is incorporated herein by reference in their entirety.

### BACKGROUND OF THE INVENTION

### Field of the Invention

The present invention relates to a vehicle control apparatus, a vehicle control method, and a storage medium.

### Description of the Related Art

In recent years, more active efforts have been made to provide access to a sustainable transportation system that takes into consideration even people at vulnerable positions such as elderly people and children among traffic participants. To achieve this, efforts have been invested in research and development for still further improving traffic safety and convenience by developing the easiness of getting in and out of vehicles. As this type of technology, technology has been proposed that detects a user around a vehicle by using, for example, an image captured by imaging the area around the vehicle and opens an openable and closeable object of the vehicle on the basis of the line-of-sight direction of the user (see, for example, Japanese Patent Laid-Open No. 2021-1447).

When a user does not get in a vehicle, the conventional technology described above has to refrain from moving an openable and closeable object of the vehicle such as a door. In contrast, when the user is about to get in the vehicle, it is desirable to quickly move the openable and closeable object.

To solve the problem described above, an object of the present application is to appropriately perform control to bring an openable and closeable object of a vehicle into operation when a user comes closer to the vehicle, and suppress an unnecessary operation of the openable and closeable object. This eventually contributes to the development of a sustainable transportation system.

### SUMMARY OF THE INVENTION

An aspect for achieving the object described above is a vehicle control apparatus including: an approach detection section configured to detect a person around a vehicle; a start control section configured to start an image capturing unit mounted on the vehicle when the approach detection section detects a person; an authentication section configured to authenticate the person detected by the approach detection section as a user of the vehicle by using an image captured by the image capturing unit and decide authentication completion under a condition that the authentication is established an authentication criterion number of times or more; and an openable and closeable object operation control section configured to bring an openable and closeable object operation unit into operation when the authentication section decides authentication completion. The openable and closeable object operation unit performs at least one of releasing a lock of an openable and closeable object and executing an opening operation of opening the openable and closeable object. The openable and closeable object is included in the vehicle.

### Advantageous Effects of Invention

When the vehicle control apparatus described above confirms that a person detected around a vehicle is a user of the vehicle by performing authentication an authentication criterion number of times or more by using a captured image, the vehicle control apparatus releases the lock of an openable and closeable object or executes an opening operation. This makes it possible to appropriately perform control to bring the openable and closeable object of the vehicle into operation when the user comes closer to the vehicle, suppress an unnecessary operation of the openable and closeable object, and increase the easiness of climbing up and down by moving the openable and closeable object, and eventually contribute to the development of a sustainable transportation system.

### BRIEF DESCRIPTION OF THE DRAWINGS

FIG. 1 is a plan view illustrating a configuration of a vehicle and a sensing range;

FIG. 2 is a side view illustrating the configuration of the vehicle;

FIG. 3 is a block diagram of a control system of the vehicle;

FIG. 4 is an explanatory diagram of a motion of a person;

FIG. 5 is a flowchart illustrating an operation of a vehicle control apparatus; and

FIG. 6 is a flowchart illustrating an operation of the vehicle control apparatus.

### DETAILED DESCRIPTION OF THE PREFERRED EMBODIMENTS

### 1. Configurations of Vehicle and Sensing Range

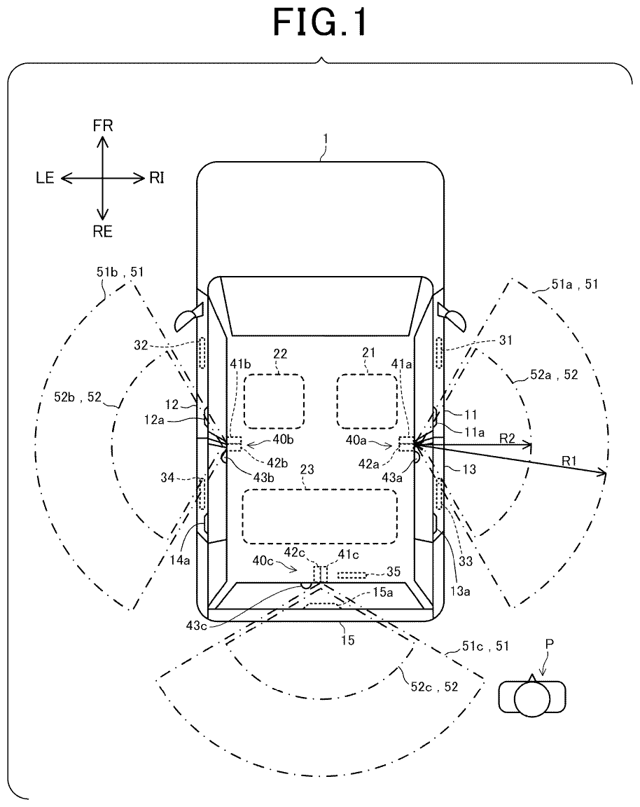

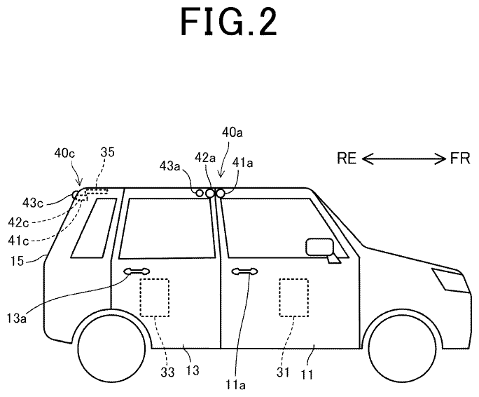

A configuration of each of units of a vehicle 1 mounted with a vehicle control apparatus 100 according to the present embodiment will be described with reference to FIGS. 1 and 2. FIG. 1 is a plan view illustrating a configuration of the vehicle 1 and a sensing range 51. FIG. 2 is a side view illustrating the configuration of the vehicle 1.

In the present embodiment, a description will be given by using, as an example, a case where the vehicle 1 mounted with the vehicle control apparatus 100 is a four-wheeled automobile including a plurality of openable and closeable objects as illustrated in each of FIGS. 1 and 2. Specifically, the vehicle 1 is a hatchback automobile including a front door 11, a front door 12, a rear door 13, a rear door 14, and a rear gate 15 as openable and closeable objects. This is an example and it is sufficient if the vehicle 1 is a mobile object that includes an openable and closeable object and allows a user to climb up and down by opening the openable and closeable object. The vehicle 1 may include any number of openable and closeable objects and the size and application of the vehicle 1, the type of a driving source, the specifications of a wheel, and the like are not limited. In addition, the openable and closeable object is an openable and closeable member that is provided on an outer surface of the vehicle 1 and particularly refers to a member that is opened and closed for the purpose of allowing a person P to climb up into the vehicle 1 and climb down from the vehicle 1 and the purpose of allowing the person P to load luggage into the vehicle 1 and unload luggage from the vehicle 1.

Although described in detail below, the vehicle control apparatus 100 is an apparatus or a device that includes a processor, a memory, an interface circuit, and the like and controls the actuation of the vehicle 1. The vehicle control apparatus 100 is, for example, an electronic control unit (ECU).

In each of FIGS. 1 and 2, the respective directions of the front, rear, right, and left of the vehicle 1 are denoted by reference signs FR, RE, RI, and LE. The front direction FR is the traveling direction of the traveling vehicle 1 and the rear direction RE is the direction of the vehicle 1 that is backing up. The vehicle 1 includes a driver's seat 21, a passenger seat 22, and a back seat 23 as seats on which occupants (users) sit down. In the present embodiment, the driver's seat 21 on which a user who is a driver sits down is disposed on the right side of the vehicle 1 and the passenger seat 22 is disposed on the left side of the vehicle 1, but this is an example. The driver's seat 21 and the passenger seat 22 may be each disposed on the opposite side in accordance with the specifications of the vehicle 1.

The front door 11 is provided in the front of the vehicle 1 on the right side surface and the rear door 13 is provided in the rear direction of the front door 11. The front door 12 is provided in the front of the vehicle 1 on the left side surface and the rear door 14 is provided in the rear direction of the front door 12. The front doors 11 and 12 are respectively provided with door handles 11a and 12a. The rear doors 13 and 14 are respectively provided with door handles 13a and 14a and a door handle 15a is attached to the rear gate 15. Each of the door handles 11a, 12a, 13a, 14a, and 15a is a handle that a user grasps to open the door.

The front door 11 is opened and closed when a user who takes the driver's seat 21 climbs up and down and the front door 12 is opened and closed when a user who takes the passenger seat 22 climbs up and down. The rear door 13 and the rear door 14 are each opened and closed, for example, when a user who takes the back seat 23 climbs up and down and when a user who takes the driver's seat 21 or the passenger seat 22 puts luggage on the back seat 23. The rear gate 15 is a door provided at the rear end of the vehicle 1 and is opened and closed for allowing a user to put luggage in the luggage space in the rear of the vehicle body of the vehicle 1.

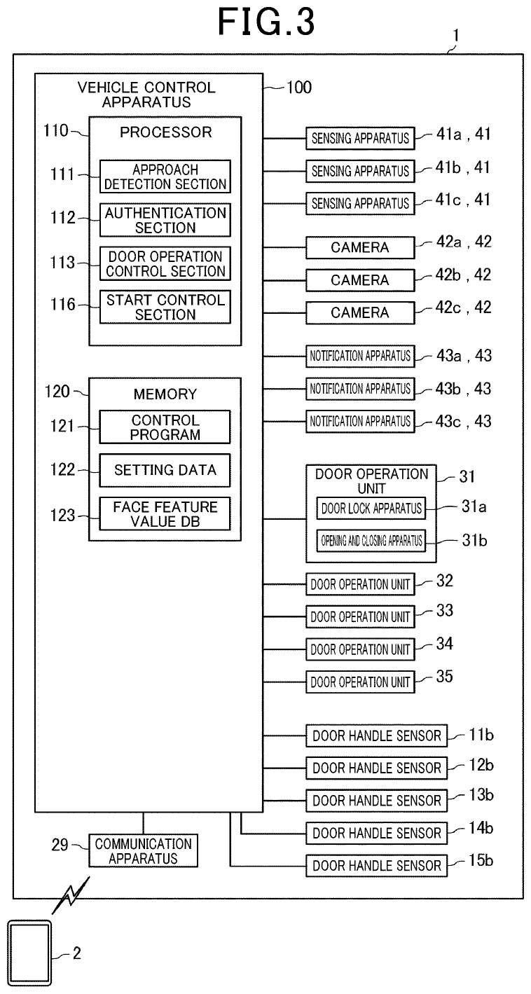

The front door 11 incorporates a door operation unit 31. The door operation unit 31 includes a door lock apparatus that releases and sets the door lock of the front door 11 as described below. In addition, the door operation unit 31 may include an apparatus that opens the front door 11 with the motive power of a motor or an actuator and the door operation unit 31 may further include an apparatus that closes the front door 11 with motive power. In the present embodiment, a configuration is exemplified in which the door operation unit 31 includes a door lock apparatus 31a and an opening and closing apparatus 31b as illustrated in FIG. 3. The door lock apparatus 31a is an apparatus that locks the front door 11 to prevent the door from opening, and sets and releases the lock in accordance with the control of the vehicle control apparatus 100. The opening and closing apparatus 31b includes an unillustrated motor or actuator and performs an opening operation of opening the front door 11 and a closing operation of closing the front door 11.

The front door 12 incorporates a door operation unit 32, the rear door 13 incorporates a door operation unit 33, and the rear door 14 incorporates a door operation unit 34. The rear gate 15 incorporates a door operation unit 35. The door operation units 32, 33, 34, and 35 each include an apparatus that sets and releases the door lock as with the door operation unit 31. The door operation unit 32 also includes an apparatus that performs an opening operation and a closing operation on the front door 12 as with the door operation unit 31. The same applies to the door operation units 33, 34, and 35. Each of the door operation units 31, 32, 33, 34, and 35 corresponds to an example of an openable and closeable object operation unit.

The vehicle 1 has a so-called smart entry function of performing authentication as to whether or not the person P is a user registered in advance when the person P approaches the vehicle 1 and, for example, releasing the door lock of the front door 12 of the vehicle 1 when the authentication is established.

As the smart entry function, the vehicle 1 detects the person P who approaches the vehicle 1 from the right direction, the left direction, or the rear direction of the vehicle 1 and performs authentication as to a user of the vehicle 1 registered in advance. The authentication as to a user refers to the authentication of the detected person P as a registered user of the vehicle 1. As components that detect and authenticate the person P, the vehicle 1 includes detection units 40a, 40b, and 40c.

The detection unit 40a is disposed on the right side surface of the vehicle 1. In the configuration of each of FIGS. 1 and 2, the detection unit 40a is buried and installed in the outer surface of the center pillar of the vehicle 1 between the front door 11 and the rear door 13. The detection unit 40b is disposed on the left side surface of the vehicle 1. The detection unit 40b is positioned between the front door 12 and the rear door 14, and buried and installed, for example, in the outer surface of the center pillar of the vehicle 1. The detection unit 40c is disposed on the rear surface of the vehicle 1. For example, the detection unit 40c is buried and installed in the upper portion of the rear gate 15.

As illustrated in FIG. 2, the detection unit 40a includes a sensing apparatus 41a, a camera 42a, and a notification apparatus 43a. The sensing apparatus 41a senses the presence of the person P within a sensing range 51a in the right direction of the vehicle 1. As a specific configuration of the sensing apparatus 41a, a passive infrared ray (PIR) sensor, a camera, a radar, or another apparatus is usable. As the radar, a millimeter wave radar that uses, for example, a frequency band of 30 GHz to 300 GHz is usable. A range within which the sensing apparatus 41a is capable of sensing the person P is set, for example, to allow the sensing apparatus 41a to sense the person P within a range of about 90° to 180° in the horizontal direction and about 90° to 150° in the vertical direction within a distance R1 from the sensing apparatus 41a. In this case, the range within which the sensing apparatus 41a is capable of sensing the person P is the fan-shaped sensing range 51a illustrated in FIG. 1.

The camera 42a is a color or monochrome digital camera. The vehicle control apparatus 100 authenticates the person P as a registered user by checking an image captured by the camera 42a against a face image of a person registered as a user of the vehicle 1 in advance. The position of the person P at which the vehicle control apparatus 100 is capable of authentication is described as an authentication range 52a. The fan-shaped authentication range 52a illustrated in FIG. 1 is, for example, a range of about 90° to 150° in the horizontal direction and about 90° to 150° in the vertical direction within a distance R2 from the camera 42a. A radius R1 of the sensing range 51a is longer than a radius R2 of the authentication range 52a. That is, when the person P approaches the vehicle 1, the person P first enters the sensing range 51a to be sensed by the sensing apparatus 41a. When the person P enters the authentication range 52a after that, the vehicle control apparatus 100 uses the camera 42a to authenticate the person P.

The notification apparatus 43a issues a notification of the operation state of the detection unit 40a. The notification apparatus 43a is an indicator including, for example, a light emitting diode (LED), an organic EL illumination element, or another illuminant. The notification apparatus 43a is on or is blinking, for example, while the camera 42a is shooting an image in accordance with the control of the vehicle control apparatus 100. This makes it possible to inform the person P outside the vehicle 1 of the operation state of the detection unit 40a.

The detection unit 40b includes a sensing apparatus 41b and a camera 42b as with the detection unit 40a. In addition, the detection unit 40c includes a sensing apparatus 41c and a camera 42c. For example, the sensing apparatuses 41b and 41c each have a configuration common to that of the sensing apparatus 41a. In this case, a sensing range 51b that is a range within which the sensing apparatus 41b senses the person P and a sensing range 51c that is a range within which the sensing apparatus 41c senses the person P are the same as the sensing range 51a in shape and size. In addition, for example, the cameras 42b and 42c each have a configuration common to that of the camera 42a. In this case, an authentication range 52b that is a range within which it is possible to authenticate the person P by using the camera 42b and an authentication range 52c that is a range within which it is possible to authenticate the person P by using the camera 42c are the same as the authentication range 52a in shape and size.

In this case, it is possible for the vehicle 1 to sense the person P within the sensing ranges 51a and 51b in the lateral direction of the vehicle 1 and the sensing range 51c in the rear direction of the vehicle 1. It is then possible for the vehicle 1 to authenticate the person P when the person P is within any of the authentication ranges 52a, 52b, and 52c in the lateral direction of the vehicle 1 and the rear direction of the vehicle 1.

In the following description, when the sensing ranges 51a, 51b, and 51c are not distinguished, the sensing ranges 51a, 51b, and 51c will be each described as a sensing range 51. Similarly, when the authentication ranges 52a, 52b, and 52c are not distinguished, the authentication ranges 52a, 52b, and 52c will be each described as an authentication range 52.

### 2. Configuration of Vehicle Control Apparatus

FIG. 3 is a block diagram of a control system of the vehicle 1. The control system of the vehicle 1 has a configuration in which each unit of the vehicle 1 is connected to the vehicle control apparatus 100.

The vehicle control apparatus 100 includes a processor 110 and a memory 120. The processor 110 is a computer including, for example, a central processing unit (CPU), a micro controller unit (MCU), and a micro processor unit (MPU). The memory 120 is a rewritable non-volatile storage apparatus and stores a program that is executed by the processor 110 and data that is processed by the processor 110. The memory 120 includes, for example, a semiconductor storage device such as a flash read only memory (ROM) or a solid state disk (SSD), or a magnetic storage device. The memory 120 may include a random access memory (RAM) that forms a work area for temporarily storing a program and data. The vehicle control apparatus 100 may include an integrated circuit (IC) that integrally includes the processor 110 and the memory 120.

The memory 120 stores a control program 121 to allow the processor 110 to read the control program 121. The control program 121 is executed by the processor 110. As the data that is processed by the processor 110, the memory 120 stores setting data 122. In addition, the storage region of the memory 120 is provided with a face feature value data base (DB) 123.

The sensing apparatuses 41a, 41b, and 41c are connected to the vehicle control apparatus 100. In addition, the cameras 42a, 42b, and 42c and the notification apparatuses 43a, 43b, and 43c are each connected to the vehicle control apparatus 100. In the following description, when the sensing apparatuses 41a, 41b, and 41c are not distinguished, the sensing apparatuses 41a, 41b, and 41c will be each described as a sensing apparatus 41. Similarly, when it is unnecessary to distinguish the individual apparatuses, the cameras 42a, 42b, and 42c will be each described as a camera 42 and the notification apparatuses 43a, 43b, and 43c will be each described as a notification apparatus 43.

The sensing apparatus 41 senses the person P within the sensing range 51 in accordance with the control of the vehicle control apparatus 100 and outputs a result of the sensing to the vehicle control apparatus 100. The camera 42 shoots an image in accordance with the control of the vehicle control apparatus 100 and outputs the captured image to the vehicle control apparatus 100. The notification apparatus 43 is turned on or blinks in accordance with the control of the vehicle control apparatus 100.

The door operation units 31, 32, 33, 34, and 35 are each connected to the vehicle control apparatus 100. As described above, in the present embodiment, the door operation unit 31 includes the door lock apparatus 31a and the opening and closing apparatus 31b. The door lock apparatus 31a included in the door operation unit 31 sets and releases the door lock of the front door 11 in accordance with the control of the vehicle control apparatus 100. The opening and closing apparatus 31b performs an opening operation and a closing operation on the front door 11 in accordance with the control of the vehicle control apparatus 100. The door operation units 32, 33, 34, and 35 set and release the locks of the respective doors or the rear gate, and perform opening operations and closing operations in accordance with the control of the vehicle control apparatus 100 as with the door operation unit 31. Each of the door locks is an example of the lock of the openable and closeable object.

A door handle sensor 11b is connected to the vehicle control apparatus 100. The door handle sensor 11b is a sensor that is provided to the door handle 11a and senses an operation on the door handle 11a. The door handle sensor 11b includes, for example, a capacitance sensor that senses a contacting operation, a push button switch that is turned on by a pushing operation, or another sensor or switch. The door handle sensors 12b, 13b, 14b, and 15b are sensors that are provided to the respective door handles 12a, 13a, 14a, and 15a and sense operations on the door handles 12a, 13a, 14a, and 15a. The door handle sensors 12b, 13b, 14b, and 15b are each configured, for example, as with the door handle sensor 11b.

When the door handle sensor 11b senses an operation on the door handle 11a, the door handle sensor 11b outputs a sensing signal to the vehicle control apparatus 100. Similarly, when the door handle sensors 12b, 13b, 14b, and 15b respectively sense operations on the door handles 12a, 13a, 14a, and 15a, the door handle sensors 12b, 13b, 14b, and 15b output sensing signals to the vehicle control apparatus 100.

A communication apparatus 29 is connected to the vehicle control apparatus 100. The communication apparatus 29 is an apparatus that communicates with an apparatus outside the vehicle 1 in accordance with the control of the vehicle control apparatus 100. The communication apparatus 29 is a wireless communication apparatus that includes, for example, an antenna which transmits and receives wireless signals, a baseband circuit, an RF circuit, and the like and executes functions of a transmitter and a receiver.

The communication apparatus 29 executes near-field communication. The communication apparatus 29 executes near-field communication that is, for example, compliant with any of Bluetooth (R), Ultra Wide Band (UWB), and another communication scheme. The communication apparatus 29 may be configured to be capable of executing wireless data communication in accordance with a cellular communication scheme such as long term evolution (LTE) or the fifth-generation mobile communication scheme (5G).

The communication apparatus 29 executes near-field communication with a terminal apparatus 2 positioned near the vehicle 1. In addition, the communication apparatus 29 may execute cellular communication and may execute data communication with the terminal apparatus 2 through an unillustrated base station or server.

The terminal apparatus 2 is an apparatus that is used by a person registered as a user of the vehicle 1, and transmits a signal to the communication apparatus 29 by using a near-field communication function. The terminal apparatus 2 is, for example, a smartphone, a tablet computer, or a notebook computer. The terminal apparatus 2 may also be an FOB key.

The sensing apparatus 41, the camera 42, the notification apparatus 43, the door operation units 31, 32, 33, 34, and 35, and the door handle sensors 11b, 12b, 13b, 14b, and 15b each operate by electric power supplied from an unillustrated battery of the vehicle 1. The vehicle control apparatus 100 is capable of performing control to start the supply of electric power to each of the units including the sensing apparatus 41 and the camera 42 and performing control to stop the supply of electric power. For example, the vehicle control apparatus 100 is connected to an unillustrated electric power supply circuit that supplies electric power to each of the units including the sensing apparatus 41 and the camera 42 and configured to perform controls to start and stop the supply of electric power by switching a switch incorporated in the electric power supply circuit.

The processor 110 includes an approach detection section 111, an authentication section 112, a door operation control section 113, and a start control section 116. These components are implemented by the processor 110 executing the control program 121.

The approach detection section 111 detects the person P who approaches the vehicle 1 on the basis of a result of sensing by the sensing apparatus 41. The approach detection section 111 identifies the sensing range 51 within which the person P is sensed among the sensing ranges 51a, 51b, and 51c by identifying the sensing apparatus 41 that senses the person P.

The authentication section 112 executes authentication as to whether or not the person P is a person registered as a user of the vehicle 1 on the basis of an image captured by the camera 42. Determining by the authentication section 112 that the person P is a registered user of the vehicle 1 is referred to as authentication establishment. Authentication failure and authentication non-establishment mean that the authentication section 112 does not determine that the person P is a user of the vehicle 1.

As a specific technique for the authentication section 112 to perform authentication, a variety of publicly known methods are usable. In the present embodiment, an example is demonstrated in which the vehicle control apparatus 100 includes the face feature value DB 123 in the memory 120 and the authentication section 112 performs authentication by using the face feature value DB 123. The face feature value DB 123 is a data base in which a feature value of an image of the face of a person registered as a user of the vehicle 1 is accumulated. The user of the vehicle 1 includes a person who drives the vehicle 1. A person who does not drive the vehicle 1, but gets in the vehicle 1 may be registered as the user.

The authentication section 112 may be configured to be capable of executing processing of registering a user of the vehicle 1. In this case, the authentication section 112 obtains a still image of the face of the user from an image captured by the camera 42 or another camera. The authentication section 112 extracts a region having a general feature value of a face from the obtained still image as the face region. The general feature value of a face is, for example, the shape of the outline of the face, the positions of the eyes and the nose relative to the outline, and another feature. The face region refers to a face image portion of the still image. The authentication section 112 sets a feature point in the face region. For example, the authentication section 112 searches the face region and the authentication section 112 sets a feature point on an eye, an eyebrow, the nose, the outline, or the like. A position at which a feature point is set and the number of feature points are set in advance by the authentication section 112 or decided by algorithm included in the control program 121. The authentication section 112 detects the feature value of a feature point and stores the detected feature value in the face feature value DB 123 in association with the user.

When the authentication section 112 performs authentication, the authentication section 112 obtains an image captured by the camera 42. For example, when the camera 42 shoots a still image, the authentication section 112 obtains the one image captured by the camera 42. In addition, for example, when the camera 42 shoots a moving image, the authentication section 112 obtains the image captured by the camera 42 for each of the frames and uses the image of the one obtained frame as one captured image. This one captured image is a still image.

The authentication section 112 extracts a face region that is an image of a human face from the one obtained captured image. The authentication section 112 sets feature points on the extracted face region as described above and detects the feature value of each of the feature points. The authentication section 112 compares a feature value detected in the captured image and a feature value stored in the face feature value DB 123 and calculates the matching rate between the feature values. The matching rate between the feature values is a so-called matching score. For example, after the authentication section 112 calculates the matching rate between the feature values for each feature point, the authentication section 112 calculates the matching rate of the one captured image on the basis of the calculated matching rate for each of the feature points. The authentication section 112 authenticates the person P as a user of the vehicle 1 on the basis of the matching rate. Specifically, when the matching rate is higher than or equal to a determination threshold set in advance, the authentication section 112 determines that an image captured by the camera 42 includes a candidate for a face image of a user. When the authentication section 112 determines that the image captured by the camera 42 includes a candidate for a face image of a user, the authentication by the authentication section 112 is established. Authentication performed by using a captured image that is one still image and authentication performed by using the image of one frame obtained from a moving image mean that authentication is performed once. When the face feature value DB 123 stores feature values of a plurality of users, the authentication section 112 selects a feature value of one person from the feature values stored in the face feature value DB 123 and repeatedly executes, by the number of registered users, processing of making a determination by calculating the matching rate with a feature value detected in a captured image.

The authentication section 112 executes authentication a plurality of times. That is, the authentication section 112 obtains the images of a plurality of frames from a moving image that is an image captured by the camera 42 and performs the authentication described above for each of the frames, or obtains a plurality of still images that is images captured by the camera 42 and performs the authentication described above for each of the still images. The authentication section 112 decides authentication completion when authentication is established a number of times (referred to as an authentication criterion number of times below) designated in advance or more in a row. That is, when authentication is established that uses a plurality of consecutive frames or authentication is established that uses a plurality of images consecutively captured, the authentication section 112 decides authentication completion. The authentication completion of the authentication section 112 refers to fixing a result of the authentication indicating that the person P is a user of the vehicle 1. In other words, authentication performed once by the authentication section 112 with one frame or one captured image can be considered tentative authentication and the authentication section 112 finally decides the completion of authentication as to a user of the vehicle 1 on the condition that the tentative authentication is established an authentication criterion number of times. Deciding authentication completion by the authentication section 112 means that a result of the authentication indicating that the person P is a user of the vehicle 1 is fixed. This equivalently means that the person P is a user of the vehicle 1 and the person P is about to get in the vehicle 1.

The authentication section 112 may use authentication established an authentication criterion number of times or more with an image captured by the one camera 42 as a condition for deciding authentication completion. For example, when the authentication section 112 obtains a plurality of frames corresponding to the authentication criterion number of times from a moving image captured by the camera 42a and the tentative authentication described above is established by using the plurality of obtained frames, the authentication section 112 decides authentication completion. In addition, for example, when the authentication section 112 obtains a plurality of captured images corresponding to the authentication criterion number of times from still images captured by the camera 42a and the tentative authentication described above is established by using the plurality of obtained captured images, the authentication section 112 decides authentication completion.

Authentication performed once by the authentication section 112, that is, tentative authentication is not limited to an example in which only one captured image that is a still image or the image of one frame is used. Authentication performed by the authentication section 112 with a predetermined number of captured images more than or equal to two captured images may be treated as authentication performed once. In this case, the authentication section 112 compares feature values, calculates the matching score by using, for example, one captured image, and makes determinations, adds up results of determinations as to the matching scores for a predetermined number of frames, and determines that tentative authentication is established when a large number of captured images have matching scores higher than or equal to the determination threshold.

In addition, for example, the authentication section 112 may add up feature values detected in the face regions of a predetermined number of captured images, obtain the average or another statistic, compare the obtained statistic with a feature value of the face feature value DB 123, and calculate the matching score.

Needless to say, it is possible for the authentication section 112 to perform authentication once in another method by using a plurality of captured images.

The authentication section 112 has a function of changing the authentication criterion number of times. In the present embodiment, the authentication section 112 is capable of changing the authentication criterion number of times in two steps. Specifically, any of the two numbers of a first number of times and a second number of times is set. The first number of times is a number larger than the second number of times.

The authentication section 112 estimates a motion of the person P detected by the approach detection section 111 on the basis of an image captured by the camera 42 and determines whether or not the estimated motion of the person P corresponds to a specific pattern. When the motion of the person P does not correspond to the specific pattern, the authentication section 112 sets the authentication criterion number of times to the second number of times. When the motion of the person P corresponds to the specific pattern, the authentication section 112 sets the authentication criterion number of times to the first number of times larger than the second number of times.

Specifically, the specific pattern according to the present embodiment is a motion of the person P who does not get in the vehicle 1, and can be regarded as a motion that helps estimate that the person P does not get in the vehicle 1. When the person P does not get in the vehicle 1, it is appropriate to bring none of the front doors 11 and 12, the rear doors 13 and 14, and the rear gate 15 that are openable and closeable objects of the vehicle 1 into operation. In contrast, when the person P wishes to get in the vehicle 1, it is possible to increase the easiness of climbing up into the vehicle 1 and climbing down from the vehicle 1 by quickly bringing an openable and closeable object of the vehicle 1 into operation. To appropriately bring an openable and closeable object of the vehicle 1 into operation, the vehicle control apparatus 100 thus determines whether or not a motion of the person P corresponds to the specific pattern, and does not move the openable and closeable object when the motion corresponds to the specific pattern. Information indicating the specific pattern is included, for example, in the setting data 122 and stored in the memory 120. The specific pattern is not limited to one moving path, but a variety of moving paths may correspond to the specific pattern. The authentication section 112 may be provided with information for designating a moving path itself that is the specific pattern, but a condition for the authentication section 112 to determine whether or not a moving path of the person P is the specific pattern is set in the authentication section 112 in advance in the present embodiment.

An example of the specific pattern includes a motion of the person P passing through the area near the vehicle 1.

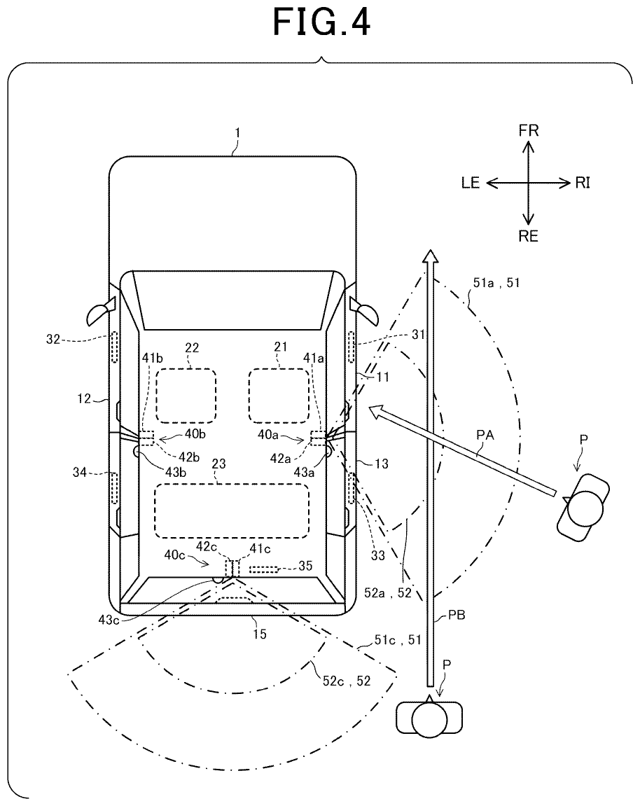

FIG. 4 is an explanatory diagram of the movement of the person P and a plan view of the vehicle 1 and the person P from the above. Paths PA and PB illustrated in FIG. 4 schematically represent moving paths of the person P detected within the sensing range 51a. The path PA is an example of a moving path taken when the person P gets in the vehicle 1, and the path PB is an example of a moving path taken when the person P does not get in the vehicle 1.

A moving path of the person P who passes through the sensing range 51a and takes the driver's seat 21 of the vehicle 1 is a path that does not substantially change the direction within the sensing range 51a, for example, like the path PA. The person P is sensed by the sensing apparatus 41a when the person P enters the sensing range 51a, and the person P is imaged by the camera 42a when the person P enters the authentication range 52a. The person P turning the face to the front door 11 appears in an image captured by imaging the person P moving along the path PA by the camera 42a. Meanwhile, a moving path of the person P who passes through the sensing range 51a, but does not get in the vehicle 1 extends in a direction different from that of the vehicle 1 like the path PB. When the person P moves along the path PB, the person P is highly likely not to turn the face to the vehicle 1. The face of the person P appearing in an image captured by the camera 42a is thus chiefly in profile.

In this way, it is possible to distinguish a path of the person P who gets in the vehicle 1 and a path of the person P who does not get in the vehicle 1 on the basis of an image captured by the camera 42a.

In addition, the path PB is a path in which the person P moves substantially straight toward the front door 11, and the person P who moves in such a direction is considered to turn the face to the front door 11 to get in the vehicle 1. The image that is the first to be captured when the person P enters the authentication range 52a among images captured by the camera 42a thus includes an image in which the person P faces the front.

The person P who does not get in the vehicle 1 is considered to enter the authentication range 52a from an end of the authentication range 52a in the horizontal direction like the path PB in many cases. In this case, in the captured image that is the first to have the person P among images captured by the camera 42a, an image of the person P is positioned at an end of the captured image in the horizontal direction. This feature also applies to a camera other than the camera 42a. For example, the person P who passes through the area in the left direction of the vehicle 1 is imaged at an end of the authentication range 52b in the horizontal direction. The authentication range 52b is the image capturing range of the camera 42b. In addition, the person P who passes through the area in the rear direction of the vehicle 1 is imaged at an end of the authentication range 52c in the horizontal direction. The authentication range 52c is the image capturing range of the camera 42c.

In addition, the movement speed of the person P who gets in the vehicle 1 is considered to decrease as the person P approaches the vehicle 1. Meanwhile, the movement speed of the person P who has no intention to get in the vehicle 1 is considered to change regardless of the distance from the vehicle 1 to the person P or be constant.

The authentication section 112 according to the present embodiment determines whether or not a motion of the person P corresponds to the specific pattern on the basis of the feature of a captured image described above. That is, when the person P is detected by the approach detection section 111 and an image of the person P is not at an end in the horizontal direction in the image that is the first to be captured by imaging the person P after the camera 42 is started, the authentication section 112 determines that the motion of the person P does not correspond to the specific pattern. In addition, when the image that is the first to be captured by imaging the person P after the camera 42 is started includes an image of the face of the person P opposed to the front, the authentication section 112 determines that the motion of the person P does not correspond to the specific pattern. In addition, the authentication section 112 detects a change in the movement speed of the person P on the basis of a captured image and determines that the motion of the person P corresponds to the specific pattern when the movement speed of the person P does not decrease as the person P comes closer to the vehicle 1. Here, the authentication section 112 may determine that the motion of the person P does not correspond to the specific pattern when the movement speed of the person P decreases as the person P comes closer to the vehicle 1.

The authentication section 112 may stand by until the person P enters the authentication range 52 after the start control section 116 described below starts the camera 42, and obtain an image captured by the camera 42 and start authentication after the person P enters the authentication range 52. That is, the authentication range 52 that is a range having the radius R2 may be set as a condition for executing the authentication processing. In addition, after the authentication section 112 determines that the traveling direction of the person P is a direction toward the vehicle 1, the authentication section 112 may quickly start authentication.

When authentication by the authentication section 112 is established, the door operation control section 113 brings any one or more of the door operation units 31, 32, 33, 34, and 35 into operation to release the door lock. After releasing the door locks, the door operation control section 113 may cause the one or more of the door operation units 31, 32, 33, 34, and 35 to execute opening operations. The door operation control section 113 selects any of the door operation units 31, 32, 33, 34, and 35, and brings the selected door operation unit into operation. The door operation control section 113 selects any of the door operation units 31, 32, 33, 34, and 35, for example, on the basis of a result of authentication by the authentication section 112, the sensing range 51 through which the person P detected by the approach detection section 111 passes, and the like. The door operation control section 113 corresponds to an example of an openable and closeable object operation control section.

When the approach detection section 111 detects the person P, the start control section 116 identifies the sensing range 51 within which the person P is detected. The start control section 116 starts the camera 42 that images the direction corresponding to the identified sensing range 51. For example, when the person P is detected within the sensing range 51a, the start control section 116 starts the camera 42a.

The sensing apparatus 41 comes into operation with the vehicle 1 parked. Parked refers to a state in which the speed of the vehicle 1 is speed close to 0 or equal to 0 and a driving source of the vehicle 1 is stopped. For example, when the driving source of the vehicle 1 is an engine, the engine is stopped while the vehicle 1 is parked. In addition, for example, when the driving source of the vehicle 1 is a driving motor, the supply of electric power to an inverter circuit or the like that supplies the driving motor with electric power is stopped while the vehicle 1 is parked. Parking the vehicle 1 includes a state in which a function of the vehicle 1 is stopped and specifically includes a state in which the ignition switch of the vehicle 1 is off. In addition, the vehicle 1 may bring the sensing apparatus 41 into operation with the vehicle 1 parked and nobody in the vehicle 1. While the sensing apparatus 41 is in operation, the approach detection section 111 obtains a result of sensing by the sensing apparatus 41 in a predetermined cycle and detects the person P within the sensing range 51 on the basis of the obtained result of sensing.

The sensing apparatus 41 may come into operation with the vehicle 1 stopped. Stopped refers to a state in which the speed of the vehicle 1 is speed close to 0 or equal to 0 and the driving source of the vehicle 1 is in operation. For example, when the driving source of the vehicle 1 is an engine, the engine is in operation while the vehicle 1 is stopped. In addition, for example, when the driving source of the vehicle 1 is a driving motor, an inverter circuit or the like that supplies the driving motor with electric power is energized and the driving motor is operable while the vehicle 1 is stopped.

It is unnecessary to bring the camera 42 into operation before the person P is detected within the sensing range 51, and the start control section 116 thus keeps the camera 42 stopped until the person P is detected within the sensing range 51. The start control section 116 may then stop the supply of electric power to the camera 42. This makes it possible to reduce the amount of electric power to be consumed for the camera 42. In addition, the authentication section 112 may execute controls to start and stop the camera 42.

FIG. 3 illustrates a variety of ECUs included in the vehicle 1 and some of the components of the vehicle 1. Needless to say, the vehicle 1 can include a component that is not illustrated in FIG. 3. In addition, the vehicle 1 does not have to include all of the components illustrated in FIG. 3. For example, the vehicle 1 does not have to include the door handle sensors 11b, 12b, 13b, 14b, and 15b.

### 3. Operation of Vehicle Control Apparatus

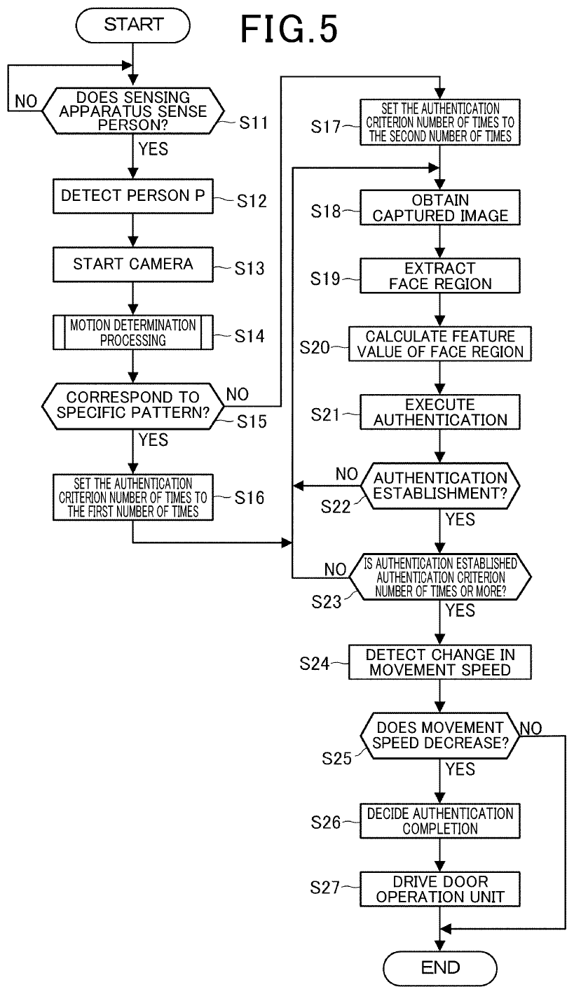

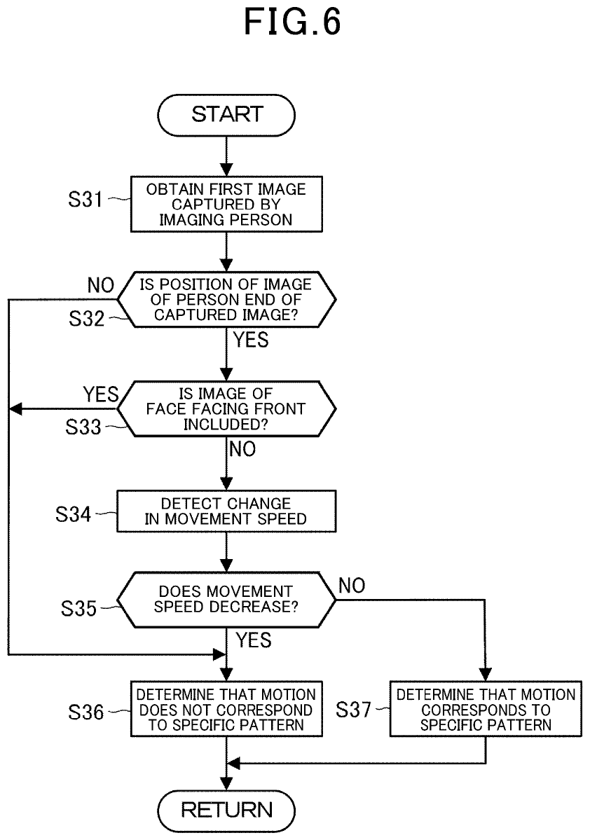

Each of FIGS. 5 and 6 is a flowchart illustrating an operation of the vehicle control apparatus 100.

In FIG. 5, the approach detection section 111 executes steps S11 to S12 and the start control section 116 executes step S13. The authentication section 112 executes steps S14 to S26 and the door operation control section 113 executes step S27.

The vehicle control apparatus 100 determines whether or not the sensing apparatus 41 senses the person P by obtaining a result of sensing by the sensing apparatus 41 (step S11). When the sensing apparatus 41 does not sense the person P (step S11; NO), the vehicle control apparatus 100 repeatedly executes step S11 in a predetermined time cycle. When the sensing apparatus 41 senses the person P (step S11; YES), the vehicle control apparatus 100 detects the presence of the person P within the sensing range 51 (step S12).

The vehicle control apparatus 100 is triggered by the detection of the person P within the sensing range 51 to start the camera 42 (step S13). In step S13, the vehicle control apparatus 100 may start all of the cameras 42a, 42b, and 42c provided to the vehicle 1. In addition, in step S13, the vehicle control apparatus 100 may start the camera 42 corresponding to the sensing range 51 within which the person P is detected.

The vehicle control apparatus 100 executes motion determination processing by using an image captured by the camera 42 after the camera 42 is started (step S14). The motion determination processing is processing of determining whether or not a motion of the person P detected in step S12 corresponds to the specific pattern. The details of the motion determination processing will be illustrated in FIG. 6.

FIG. 6 is a flowchart illustrating the motion determination processing of step S14 in detail and steps S31 to S37 are executed by the authentication section 112.

The vehicle control apparatus 100 obtains the first image captured by imaging the person P among images captured by the camera 42 (step S31). The vehicle control apparatus 100 determines whether or not the position of an image of the person P is an end of the obtained captured image (step S32). If described in detail, the vehicle control apparatus 100 extracts an image of the person P from the captured image obtained in step S31 and determines whether or not the extracted image is positioned at an end of the captured image in the horizontal direction in step S32.

When the position of the image of the person P is not an end of the captured image (step S32; NO), the vehicle control apparatus 100 transitions to step S36 described below. When the position of the image of the person P is an end of the captured image (step S32; YES), the vehicle control apparatus 100 determines whether or not the captured image obtained in step S31 includes an image of the face opposed to the front (step S33).

When the captured image includes an image of the face opposed to the front (step S33; YES), the vehicle control apparatus 100 transitions to step S36 described below. When the captured image does not include an image of the face opposed to the front (step S33; NO), the vehicle control apparatus 100 transitions to step S34.

In step S34, the vehicle control apparatus 100 detects a change in the movement speed of the person P by using a plurality of images captured by the one camera 42 (step S34). For example, the vehicle control apparatus 100 obtains a plurality of images captured by the camera 42 and estimates the movement speed of the person P on the basis of a change of the position of an image of the person P in the respective captured images in step S34. The vehicle control apparatus 100 then determines whether or not the movement speed of the person P is decreasing over time (step S35). In step S35, the vehicle control apparatus 100 may determine whether or not the movement speed of the person P decreases over time. In addition, the vehicle control apparatus 100 may also estimate the position of the person P when estimating the movement speed in step S34. In this case, the vehicle control apparatus 100 determines in step S35 whether or not the movement speed of the person P decreases as the person P comes closer to the vehicle 1.

When the vehicle control apparatus 100 determines that the movement speed of the person P is decreasing (step S35; YES), the vehicle control apparatus 100 transitions to step S36. In step S36, the vehicle control apparatus 100 determines that the motion of the person P does not correspond to the specific pattern (step S36). In addition, when the vehicle control apparatus 100 determines that the movement speed of the person P does not decrease (step S35; NO), the vehicle control apparatus 100 determines that the motion of the person P corresponds to the specific pattern (step S37).

FIG. 5 will be referenced again, and the vehicle control apparatus 100 refers to a result of the determination of the motion determination processing in step S14 and determines whether or not the motion of the person P corresponds to the specific pattern (step S15). When the motion of the person P corresponds to the specific pattern (step S15; YES), the vehicle control apparatus 100 sets the authentication criterion number of times to the first number of times (step S16) and transitions to step S18. When the motion of the person P does not correspond to the specific pattern (step S15; NO), the vehicle control apparatus 100 sets the authentication criterion number of times to the second number of times (step S17) and transitions to step S18.

When the motion of the person P does not correspond to the specific pattern, the processing in step S16 and step S17 causes the authentication criterion number of times to be set to a smaller number of times than the authentication criterion number of times set when the motion of the person P corresponds to the specific pattern.

The vehicle control apparatus 100 authenticates the person P in steps S18 to S22. Steps S18 to S22 correspond to tentative authentication performed once. The vehicle control apparatus 100 obtains an image captured by the camera 42 in step S18 (step S18). In step S18, the vehicle control apparatus 100 obtains one still image or one captured image including one frame as described above. The vehicle control apparatus 100 extracts a face region from the obtained captured image (step S19). The vehicle control apparatus 100 calculates a feature value of the face region (step S20) and performs authentication on the basis of the calculated feature value (step S21). In step S21, for example, as described above, the matching score is calculated between the feature value calculated from the face region and a feature value stored in the face feature value DB 123 and the calculated matching score is compared with the determination threshold.

The vehicle control apparatus 100 determines whether or not the authentication is established (step S22). For example, when the matching score is higher than or equal to the determination threshold, the vehicle control apparatus 100 determines that the authentication is established. When the authentication is not established (step S22; NO), the vehicle control apparatus 100 returns to step S18.

When the authentication is established (step S22; YES), the vehicle control apparatus 100 determines whether or not the authentication is established an authentication criterion number of times or more (step S23). In step S23, the vehicle control apparatus 100 may determine whether or not the authentication is established an authentication criterion number of times or more in a row. When the authentication is not established an authentication criterion number of times or more (step S23; NO), the vehicle control apparatus 100 returns to step S18. When the authentication is established an authentication criterion number of times or more (step S23; YES), the vehicle control apparatus 100 transitions to step S24.

In step S24, the vehicle control apparatus 100 detects a change in the movement speed of the person P (step S24). The operation in step S24 is similar to that of step S34 described above and the vehicle control apparatus 100 detects a change in the movement speed of the person P by using a plurality of images captured by the one camera 42. Subsequently, the vehicle control apparatus 100 determines as in step S35 whether or not the movement speed of the person P decreases (step S25).

When the vehicle control apparatus 100 determines that the movement speed of the person P does not decrease (step S25; NO), the vehicle control apparatus 100 ends this processing. When it is determined that the movement speed of the person P decreases (step S25; YES), it is decided that the authentication is completed or authentication completion is decided (step S26). That is, through the processing in steps S24 to S26, the vehicle control apparatus 100 decides authentication completion under both conditions that the authentication is established an authentication criterion number of times or more and the movement speed of the person P decreases as the person P approaches the vehicle 1.

After the vehicle control apparatus 100 decides authentication completion, the vehicle control apparatus 100 brings any one or more of the door operation units 31, 32, 33, 34, and 35 into operation (step S27). In step S27, the vehicle control apparatus 100 selects an openable and closeable object to be brought into operation from the front doors 11 and 12, the rear doors 13 and 14, and the rear gate 15. The vehicle control apparatus 100 brings the door operation unit into operation that is provided to the openable and closeable object selected from the door operation units 31, 32, 33, 34, and 35. This releases the door lock of any of the openable and closeable objects of the vehicle 1 or causes an opening operation to be executed on any of the openable and closeable objects of the vehicle 1. After that, the vehicle control apparatus 100 ends this processing, and returns to step S11 and continues standing by, for example, when the vehicle 1 is parked.

Operations illustrated in FIGS. 5 and 6 are examples. For example, when the vehicle control apparatus 100 determines in step S25 that the movement speed of the person P does not decrease (step S25; NO), the vehicle control apparatus 100 may standby for a predetermined time and then make a determination in step S25 again.

In addition, timings for the vehicle control apparatus 100 to execute steps S14 to S17 including the motion determination processing are not limited to the example of FIG. 5. The vehicle control apparatus 100 may perform the processing in steps S14 to S17 in parallel with other processing. For example, the vehicle control apparatus 100 executes first processing (steps S14 to S17) and second processing (steps S18 to S22) in parallel after step S13. In this case, it is sufficient if the authentication criterion number of times is decided through the first processing before a determination is made in step S23.

### 4. Other Embodiments

In the embodiment described above, the sensing range 51 and the authentication range 52 are illustrated as fan-shaped ranges that have overlapping centers, but this is an example. The shapes and sizes of the sensing range 51 and the authentication range 52 are not limited to the example illustrated in FIG. 1. In addition, the authentication range 52 does not have to be inside the sensing range 51. In addition, in the embodiment described above, the configuration has been exemplified in which the vehicle 1 includes the three detection units 40a, 40b, and 40c corresponding to the areas in the rear direction and the lateral direction of the vehicle 1, but this is an example. A larger number of detection units may be provided to the vehicle 1. For example, the vehicle 1 may be provided with a detection unit that has the sensing range 51 and the authentication range 52 including the area in the front direction of the vehicle 1. This detection unit may be, for example, a camera or a sensor used for the advanced driver-assistance systems (ADAS) of the vehicle 1, or a camera or a sensor used for a security apparatus of the vehicle 1. In addition, the example has been described in which each of the detection units 40a and 40b is buried and installed in the outer surface of the center pillar of the vehicle 1 between the front door 11 and the rear door 13, but this is an example. For example, one or both of the detection unit 40a and the detection unit 40b may be installed on the roof of the vehicle 1. In addition, for example, one or both of the detection unit 40a and the detection unit 40b may be buried and installed at positions overlapping with the pillar or positions overlapping with the area near the pillar on the outer surfaces of the front door 11 and the rear door 13.

The operation for authentication described in the embodiment above is an example. For example, the authentication section 112 may perform authentication processing by using images captured by the plurality of cameras 42 among the cameras 42a, 42b, and 42c included in the vehicle 1. Needless to say, it is possible to adopt authentication processing compliant with another method.

FIG. 3 is a schematic diagram in which the configuration of the vehicle control apparatus 100 is divided in accordance with the chief processing contents to facilitate the understandings of the invention according to the present application, but the vehicle control apparatus 100 may be configured in accordance with other division. In addition, the processing of each of the components may be executed by one hardware unit or executed by a plurality of hardware units. The processing illustrated in each of FIGS. 5 and 6 may be executed by one program or executed by a plurality of programs. In addition, the vehicle control apparatus 100 may include one ECU or functions of the vehicle control apparatus 100 may be executed by a plurality of ECUs.

The processing units of the flowchart illustrated in each of FIGS. 5 and 6 result from division compliant with the chief processing contents to facilitate the understandings of the processing by the vehicle control apparatus 100, but the present invention is not limited by the way of the division or the name of the processing units. It is also possible to further divide this processing into more processing units in accordance with the processing contents or further divide this processing to cause one processing unit to include more processing. In addition, the processing order of any of the flowcharts described above is not also limited to the illustrated example.

In the embodiment described above, the vehicle control apparatus according to the present invention is configured by the execution of the control program 121 by the processor 110 of the vehicle control apparatus 100 included in the vehicle 1 and the processor 110 executes the vehicle control method. As another embodiment, the vehicle control apparatus may be configured on a server that communicates with the vehicle 1 by the execution of a vehicle control program by a computer included in the server and the computer may execute the vehicle control method. In this case, a user who approaches the vehicle 1 is authenticated on the basis of a captured image of the area around the vehicle 1 that is transmitted from the vehicle 1 to the server and the user is permitted entry to the vehicle 1.

The control program 121 that is executed by the processor 110 according to the present embodiment is not only configured to be stored in the memory 120, but is also implementable as stored in a non-transitory computer-readable storage medium. As the non-transitory computer-readable storage medium, for example, a magnetic storage apparatus, a magnetic recording medium, an optical recording medium, or a semiconductor memory device is usable. Specifically, portable or stationary recording media such as a flexible disk, a hard disk drive (HDD), a CD-ROM, a DVD, a magneto-optical disk, a flash memory, and a card-shaped recording medium are included. The non-transitory computer-readable storage medium may be a non-volatile storage apparatus such as a RAM, a ROM, or an HDD that is an internal storage apparatus included in a computer including the vehicle control apparatus 100.

### 5. Configurations Supported by Embodiments Above

The embodiments described above are specific examples of the following configurations.

### Configuration 1

A vehicle control apparatus including: an approach detection section configured to detect a person around a vehicle; a start control section configured to start an image capturing unit mounted on the vehicle when the approach detection section detects a person; an authentication section configured to authenticate the person detected by the approach detection section as a user of the vehicle by using an image captured by the image capturing unit and decide authentication completion under a condition that the authentication is established an authentication criterion number of times or more; and an openable and closeable object operation control section configured to bring an openable and closeable object operation unit into operation when the authentication section decides authentication completion, the openable and closeable object operation unit performing at least one of releasing a lock of an openable and closeable object and executing an opening operation of opening the openable and closeable object, the openable and closeable object being included in the vehicle.

The vehicle control apparatus according to Configuration 1 releases a lock or executes an opening operation on an openable and closeable object when confirming that a person detected around a vehicle is a user of the vehicle by performing authentication an authentication criterion number of times or more by using a captured image. For example, when a user passes through an area around the vehicle with no intention to get in the vehicle, the user goes away from the vehicle before authentication is established an authentication criterion number of times or more, and the openable and closeable object thus performs no operation. This suppresses the movement of the openable and closeable object of the vehicle when the user does not have the intention to get in the vehicle. This makes it possible to appropriately perform control to bring the openable and closeable object of the vehicle into operation when the user comes closer to the vehicle, suppress an unnecessary operation of the openable and closeable object, and increase the easiness of climbing up and down by moving the openable and closeable object, and eventually contribute to the development of a sustainable transportation system.

### Configuration 2

The vehicle control apparatus according to Configuration 1, in which the authentication section obtains an image of one frame included in the captured image and performs the authentication once on the basis of whether or not the obtained image of the one frame includes a face image of the user of the vehicle.

The vehicle control apparatus according to Configuration 2 obtains one frame of a moving image captured by an image capturing unit to perform authentication once and executes an operation for an openable and closeable object when this authentication is established an authentication criterion number of times or more. This makes it possible to effectively suppress the movement of the openable and closeable object of a vehicle when a user has no intention to get in the vehicle and more appropriately perform control to bring the openable and closeable object of the vehicle into operation when the user comes closer to the vehicle.

### Configuration 3

The vehicle control apparatus according to Configuration 1 or 2, in which the authentication section determines whether or not a motion of the person detected by the approach detection section corresponds to a specific pattern, decides the authentication completion under the condition that the authentication is established the authentication criterion number of times or more when the motion of the person detected by the approach detection section corresponds to the specific pattern, and decides the authentication completion under a condition that the authentication is established a smaller number of times than the authentication criterion number of times when the motion of the person detected by the approach detection section does not correspond to the specific pattern.

The vehicle control apparatus according to Configuration 3 moves an openable and closeable object under a condition that authentication is established a larger number of times when a motion of a person detected near a vehicle is, for example, a motion different from a motion of getting in the vehicle. This makes it possible to suppress the movement of the openable and closeable object of the vehicle for a user who has no intention to get in the vehicle.

### Configuration 4

The vehicle control apparatus according to Configuration 3, in which the authentication section determines whether or not the motion of the person detected by the approach detection section corresponds to the specific pattern on the basis of at least one of a position of an image of a person in the captured image and a change of the position of the image of the person in the captured image.

The vehicle control apparatus according to Configuration 4 makes it possible to more appropriately determine a motion of a person detected near a vehicle on the basis of a captured image.

### Configuration 5

The vehicle control apparatus according to Configuration 3 or 4, in which the specific pattern is a motion of passing through an image capturing range of the image capturing unit of the vehicle, and when the captured image includes a person who is imaged at a left end or a right end of the image capturing range of the image capturing unit, the authentication section determines that the motion of the person detected by the approach detection section corresponds to the specific pattern.

The vehicle control apparatus according to Configuration 5 makes it possible to appropriately determine whether or not a motion of a person detected near a vehicle is a motion of passing through an image capturing range of the image capturing unit of the vehicle by using a captured image.

### Configuration 6

The vehicle control apparatus according to any one of Configurations 3 to 5, in which, when a first image captured by imaging the person detected by the approach detection section after the image capturing unit is started includes an image of a face of the person facing front detected by the approach detection section, the authentication section determines that the motion of the person detected by the approach detection section does not correspond to the specific pattern.

The vehicle control apparatus according to Configuration 6 moves an openable and closeable object under a condition that authentication is established a smaller number of times when a person detected near a vehicle turns the face to the vehicle in the initial stage of the movement because the will of getting in the vehicle is clear. This makes it possible to quickly move the openable and closeable object for a user having an intention to get in the vehicle and increase easiness of climbing up and down.

### Configuration 7

The vehicle control apparatus according to any one of Configurations 3 to 6, in which the authentication section obtains movement speed of the person detected by the approach detection section and determines that the motion of the person detected by the approach detection section does not correspond to the specific pattern when the movement speed decreases as the person detected by the approach detection section approaches the vehicle.

The vehicle control apparatus according to Configuration 7 makes it possible to more appropriately perform control to bring an openable and closeable object of a vehicle into operation when a user comes closer to the vehicle on the basis of the knowledge that a person who is decreasing in movement speed as the person comes closer to the vehicle is highly likely to wish to get in the vehicle.

### Configuration 8

The vehicle control apparatus according to any one of Configurations 1 to 7, in which the authentication section obtains movement speed of the person detected by the approach detection section and decides the authentication completion under both conditions that the movement speed decreases as the person detected by the approach detection section approaches the vehicle, and the authentication is established the authentication criterion number of times or more.

The vehicle control apparatus according to Configuration 8 makes it possible to more appropriately perform control to bring an openable and closeable object of a vehicle into operation when a user comes closer to the vehicle on the basis of the knowledge that a user who wishes to get in the vehicle decreases in movement speed as the user comes closer to the vehicle.

### Configuration 9

A vehicle control method that is executed by a computer, the vehicle control method including: detecting a person around a vehicle; starting an image capturing unit mounted on the vehicle when a person around the vehicle is detected; authenticating the detected person as a user of the vehicle by using an image captured by the image capturing unit and deciding authentication completion under a condition that the authentication is established an authentication criterion number of times or more; and bringing an openable and closeable object operation unit into operation when the authentication completion is decided, the openable and closeable object operation unit performing at least one of releasing a lock of an openable and closeable object and executing an opening operation of opening the openable and closeable object, the openable and closeable object being included in the vehicle.

The vehicle control method according to Configuration 9 releases a lock or executes an opening operation on an openable and closeable object when confirming that a person detected around a vehicle is a user of the vehicle by performing authentication an authentication criterion number of times or more by using a captured image. For example, when a user passes through an area around the vehicle with no intention to get in the vehicle, the user goes away from the vehicle before authentication is established an authentication criterion number of times or more, and the openable and closeable object thus performs no operation. This suppresses the movement of the openable and closeable object of the vehicle when the user does not have the intention to get in the vehicle. This makes it possible to appropriately perform control to bring the openable and closeable object of the vehicle into operation when the user comes closer to the vehicle, suppress an unnecessary operation of the openable and closeable object, and increase the easiness of climbing up and down by moving the openable and closeable object, and eventually contribute to the development of a sustainable transportation system.

### Configuration 10

A non-transitory computer-readable storage medium storing a program that is executable by a computer, the program causing the computer to function as: an approach detection section configured to detect a person around a vehicle; a start control section configured to start an image capturing unit mounted on the vehicle when the approach detection section detects a person; an authentication section configured to authenticate the person detected by the approach detection section as a user of the vehicle by using an image captured by the image capturing unit and decide authentication completion under a condition that the authentication is established an authentication criterion number of times or more; and an openable and closeable object operation control section configured to bring an openable and closeable object operation unit into operation when the authentication section decides authentication completion, the openable and closeable object operation unit performing at least one of releasing a lock of an openable and closeable object and executing an opening operation of opening the openable and closeable object, the openable and closeable object being included in the vehicle.

The program according to Configuration 10 releases a lock or executes an opening operation on an openable and closeable object when confirming that a person detected around a vehicle is a user of the vehicle by performing authentication an authentication criterion number of times or more by using a captured image. For example, when a user passes through an area around the vehicle with no intention to get in the vehicle, the user goes away from the vehicle before authentication is established an authentication criterion number of times or more, and the openable and closeable object thus performs no operation. This suppresses the movement of the openable and closeable object of the vehicle when the user does not have the intention to get in the vehicle. This makes it possible to appropriately perform control to bring the openable and closeable object of the vehicle into operation when the user comes closer to the vehicle, suppress an unnecessary operation of the openable and closeable object, and increase the easiness of climbing up and down by moving the openable and closeable object, and eventually contribute to the development of a sustainable transportation system.

### REFERENCE SIGNS LIST

1 vehicle
2 terminal apparatus
11, 12 front door (openable and closeable object)
11a, 12a, 13a, 14a, 15a door handle
11b, 12b, 13b, 14b, 15b door handle sensor
13, 14 rear door (openable and closeable object)
15 rear gate (openable and closeable object)
29 communication apparatus
31, 32, 33, 34, 35 door operation unit (openable and closeable object operation unit)
31a door lock apparatus
31b opening and closing apparatus
40a, 40b, 40c detection unit
41, 41a, 41b, 41c sensing apparatus
42, 42a, 42b, 42c camera (image shooting unit)
43, 43a, 43b, 43c notification apparatus
51, 51a, 51b, 51c sensing range
52, 52a, 52b, 52c authentication range
100 vehicle control apparatus
110 processor
111 approach detection section
112 authentication section
113 door operation control section (openable and closeable object operation control section)
116 start control section
120 memory
121 control program
122 setting data
123 face feature value DB

What is claimed is:

1. A vehicle control apparatus comprising a processor configured to:
detect a person around a vehicle;
start a camera mounted on the vehicle when the person is detected around the vehicle;
authenticate the person detected as a user of the vehicle by using an image captured by the camera and decide authentication completion under a condition that authentication is established an authentication criterion number of times or more; and
bring an openable and closeable object operation unit into operation when the processor decides authentication completion, the openable and closeable object operation unit at least releasing a lock of an openable and closeable object or executing an opening operation of opening the openable and closeable object, the openable and closeable object being included in the vehicle,
wherein the processor is configured to calculate a movement speed of the person detected in the image captured, determine that the motion of the person is a motion of getting in the vehicle when the movement speed decreases as the person approaches the vehicle, and change a setting of face authentication based on a result of a determination.

2. The vehicle control apparatus according to claim 1, wherein the processor is configured to obtain an image of one frame included in the captured image and perform the authentication once on a basis of whether or not the obtained image of the one frame includes the face image of the user of the vehicle.

3. The vehicle control apparatus according to claim 1, wherein the processor is configured to
determine whether or not the motion of the person detected corresponds to a specific pattern,
decide the authentication completion under a condition that the authentication is established the authentication criterion number of times or more when the motion of the person detected corresponds to the specific pattern, and
decide the authentication completion under a condition that the authentication is established a smaller number of times than the authentication criterion number of times when the motion of the person detected does not correspond to the specific pattern.

4. The vehicle control apparatus according to claim 3, wherein the processor is configured to determine whether or not the motion of the person detected corresponds to the specific pattern on a basis of at least one of a position of the image of the person in the captured image and a change of the position of the image of the person in the captured image.

5. The vehicle control apparatus according to claim 3, wherein
the specific pattern is a motion of passing through an image capturing range of the camera of the vehicle, and
when the captured image includes a person who is imaged at a left end or a right end of the image capturing range of the camera, the processor is configured to determine that the motion of the person detected corresponds to the specific pattern.

6. The vehicle control apparatus according to claim 3, wherein, when a first image captured by imaging the person detected after the camera is started includes the image of the of the person facing front detected, the processor is configured to determine that the motion of the person detected does not correspond to the specific pattern.

7. The vehicle control apparatus according to claim 3, wherein the processor is configured to determine that the motion of the person detected does not correspond to the specific pattern when the movement speed decreases as the person detected approaches the vehicle.

8. The vehicle control apparatus according to claim 1, wherein the processor is configured to decide the authentication completion under both conditions that the movement speed decreases as the person detected approaches the vehicle, and the authentication is established the authentication criterion number of times or more.

9. A vehicle control apparatus comprising a processor configured to:
detect a person around a vehicle;
start a camera mounted on the vehicle when the person is detected around the vehicle;
authenticate the person detected as a user of the vehicle by using an image captured by the camera and decide authentication completion under a condition that authentication is established an authentication criterion number of times or more; and
bring an openable and closeable object operation unit into operation when the authentication section decides authentication completion, the openable and closeable object operation unit at least releasing a lock of an openable and closeable object or executing an opening operation of opening the openable and closeable object, the openable and closeable object being included in the vehicle,
wherein the processor is configured to determine that the motion of the person is a motion of not getting in the vehicle when an image of the person is positioned at an end of the image captured in a horizontal direction, and change a setting of face authentication based on a result of a determination.

10. The vehicle control apparatus according to claim 9, wherein the processor is configured to obtain an image of one frame included in the captured image and perform the authentication once on a basis of whether or not the obtained image of the one frame includes the face image of the user of the vehicle.

11. The vehicle control apparatus according to claim 9, wherein the processor is configured to
determine whether or not the motion of the person detected corresponds to a specific pattern,
decide the authentication completion under a condition that the authentication is established the authentication criterion number of times or more when the motion of the person detected corresponds to the specific pattern, and
decide the authentication completion under a condition that the authentication is established a smaller number of times than the authentication criterion number of times when the motion of the person detected does not correspond to the specific pattern.

12. The vehicle control apparatus according to claim 11, wherein the processor is configured to determine whether or not the motion of the person detected corresponds to the specific pattern on a basis of at least one of a position of the image of the person in the captured image and a change of the position of the image of the person in the captured image.

13. The vehicle control apparatus according to claim 11, wherein
the specific pattern is a motion of passing through an image capturing range of the camera of the vehicle, and
when the captured image includes a person who is imaged at a left end or a right end of the image capturing range of the camera, the processor is configured to determine that the motion of the person detected corresponds to the specific pattern.

14. The vehicle control apparatus according to claim 11, wherein, when a first image captured by imaging the person detected after the camera is started includes the image of the of the person facing front detected, the processor is configured to determine that the motion of the person detected does not correspond to the specific pattern.

15. The vehicle control apparatus according to claim 11, wherein the processor is configured to obtain movement speed of the person detected and determine that the motion of the person detected does not correspond to the specific pattern when the movement speed decreases as the person detected approaches the vehicle.

16. The vehicle control apparatus according to claim 9, wherein the processor is configured to obtain movement speed of the person detected and decide the authentication completion under both conditions that the movement speed decreases as the person detected approaches the vehicle, and the authentication is established the authentication criterion number of times or more.

17. A vehicle control method that is executed by a computer, the vehicle control method comprising:
detecting a person around a vehicle;
starting a camera mounted on the vehicle when a person around the vehicle is detected;
authenticating the detected person as a user of the vehicle by using an image captured by the camera and deciding authentication completion under a condition that the authentication is established an authentication criterion number of times or more; and
bringing an openable and closeable object operation unit into operation when the authentication completion is decided, the openable and closeable object operation unit performing at least one of releasing a lock of an openable and closeable object and executing an opening operation of opening the openable and closeable object, the openable and closeable object being included in the vehicle,
wherein authenticating the detected person as the user of the vehicle further comprises calculating a movement speed of the person detected in the image captured, determining that the motion of the person is a motion of getting in the vehicle when the movement speed decreases as the person approaches the vehicle, and changing a setting of face authentication based on a result of a determination.

18. A vehicle control method that is executed by a computer, the vehicle control method comprising:
detecting a person around a vehicle;
starting a camera mounted on the vehicle when a person around the vehicle is detected;
authenticating the detected person as a user of the vehicle by using an image captured by the camera and deciding authentication completion under a condition that the authentication is established an authentication criterion number of times or more; and
bringing an openable and closeable object operation unit into operation when the authentication completion is decided, the openable and closeable object operation unit performing at least one of releasing a lock of an openable and closeable object and executing an opening operation of opening the openable and closeable object, the openable and closeable object being included in the vehicle,
wherein authenticating the detected person as the user of the vehicle further comprises determining that the motion of the person is a motion of not getting in the vehicle when an image of the person is positioned at an end of the image captured in a horizontal direction, and changing a setting of face authentication based on a result of a determination.

19. A non-transitory computer-readable storage medium storing a program that is executable by a computer, the program causing the computer to:
detect a person around a vehicle;
start a camera mounted on the vehicle when the person is detected around the vehicle;
authenticate the person detected as a user of the vehicle by using an image captured by the camera and decide authentication completion under a condition that the authentication is established an authentication criterion number of times or more;
bring an openable and closeable object operation unit into operation when the authentication completion is decided, the openable and closeable object operation unit performing at least one of releasing a lock of an openable and closeable object and executing an opening operation of opening the openable and closeable object, the openable and closeable object being included in the vehicle; and
calculate a movement speed of the person detected in the image captured, determine that the motion of the person is a motion of getting in the vehicle when the movement speed decreases as the person approaches the vehicle, and change a setting of face authentication based on a result of a determination.

20. A non-transitory computer-readable storage medium storing a program that is executable by a computer, the program causing the computer to:
detect a person around a vehicle;
start a camera mounted on the vehicle when the person is detected around the vehicle;
authenticate the person detected as a user of the vehicle by using an image captured by the camera and decide authentication completion under a condition that the authentication is established an authentication criterion number of times or more;
bring an openable and closeable object operation unit into operation when the authentication completion is decided, the openable and closeable object operation unit performing at least one of releasing a lock of an openable and closeable object and executing an opening operation of opening the openable and closeable object, the openable and closeable object being included in the vehicle; and
determine that the motion of the person is a motion of not getting in the vehicle when an image of the person is positioned at an end of the image captured in a horizontal direction, and change a setting of face authentication based on a result of a determination.
